(19) United States
(12) Patent Application Publication
(10) Pub. No.: US 2009/0052696 A1
(43) Pub. Date: Feb. 26, 2009

(54) Electroacoustic transducer

(75) Inventor: Masayuki Iwamatsu, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/157,553

(22) Filed: Jun. 11, 2008

(30) Foreign Application Priority Data
Jun. 13, 2007 (JP) 2007-156203

(51) Int. Cl. H04R 3/00

(52) U.S. Cl. 381/111

(57) ABSTRACT

An electroacoustic transducer includes a single package, a microphone provided in the single package, an amplifier provided in the single package, and a controller provided in the single package. The microphone converts an acoustic pressure into an electrical signal. The amplifier amplifies the electrical signal that is output from the microphone. The amplifier is configured to allow the gain to be adjustable. The controller controls the gain of the amplifier, with reference to the level of an output signal from the amplifier, so as to prevent the output signal from being clipped.

### BACKGROUND OF THE INVENTION

1. Field of the Invention

The present invention generally relates to an electroacoustic transducer that amplifies an input signal from a microphone. More specifically, the present invention relates to an electroacoustic transducer that prevents continuous clipping upon input of large sound volume.

Priority is claimed on Japanese Patent Application No. 2007-156203, filed Jun. 13, 2007, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

Japanese Unexamined Patent Application, First Publication, No. 2003-259479 discloses a conventional microphone device that automatically corrects the sensitivity by adjusting the gain of an amplifier of the microphone device in accordance with the sound volume of a sound source. FIG. 7 is a block diagram illustrating the configuration of a conventional microphone device having a capacitive microphone. A capacitive microphone C_{MIC} is adapted to cause small capacitive variation due to an input acoustic pressure, while the capacitive microphone C_{MIC} is biased by a high resistance R_{B}, thereby generating voltage variation in proportion to the acoustic pressure. The voltage variation is fetched through a source of a field effect transistor FET performing as an impedance converter, wherein the field effect transistor FET has a gate that is coupled to a coupling capacitor C1 and a high resistance R_{H}. The voltage variation is then amplified by an amplifier “A” at a gain of 20 dB, thereby generating an output signal Out.

In the conventional microphone device, the amplifier “A” has a threshold input of −20 dB which corresponds to the maximum amplitude of undistorted output of the amplifier “A”. When the amplitude of the output from the field effect transistor exceeds the threshold input under large sound volume, then the clipping is caused at the amplifier “A” and the amplifier “A” generates distorted output signal Out.

When the gain of the amplifier “A” is reduced in order to prevent such strain, the amplitude of the output signal in normal state is also reduced, thereby deteriorating the signal-to-noise ratio. The above-described document proposes changing the gain of the microphone amplifier, without taking into account the problem with the clipping under large sound volume. If the microphone device has a fraction to prevent the clipping, it is no longer necessary to taking into account the countermeasure in subsequent design process, thereby making it easy to design the electroacoustic transducer.

In view of the above, it will be apparent to those skilled in the art from this disclosure that there exists a need for an improved electroacoustic transducer. This invention addresses this need in the art as well as other needs, which will become apparent to those skilled in the art from this disclosure.

### SUMMARY OF THE INVENTION

Accordingly, it is a primary object of the present invention to provide an electroacoustic transducer.

It is another object of the present invention to provide an electroacoustic transducer performing as an amplifier-integrated microphone device that sufficiently amplifies voltage variation upon small sound volume, and that prevents the clipping upon large sound volume.

In accordance with a first aspect of the present invention, an electroacoustic transducer may include, but is not limited to, a single package, a microphone provided in the single package, an amplifier provided in the single package, and a controller provided in the single package. The microphone converts an acoustic pressure into an electrical signal. The amplifier amplifies the electrical signal that is output from the microphone. The amplifier is configured to allow the gain to be adjustable. The controller controls the gain of the amplifier, with reference to the level of an output signal from the amplifier, so as to prevent the output signal from being clipped.

The microphone, the amplifier and the controller are integrated in the single package that is used for the electroacoustic transducer. The controller controls the gain of the amplifier, with reference to the level of the output signal from the amplifier, so as to prevent the output signal from the amplifier from being clipped. The electroacoustic transducer performs an amplifier-integrated microphone device that performs sufficient amplification upon input of small sound volume as well as that prevents the output signal from being clipped upon input of large sound volume.

In some cases, the electroacoustic transducer may further include an impedance converter provided in the single package. The impedance converter is interposed between the microphone and the amplifier. The impedance converter reducing the output impedance of the microphone.

In some cases, the controller may further include first and second comparators. The first comparator compares the potential of the output signal from the amplifier to a first potential. The first potential corresponds to an upper threshold for causing the clipping of the output signal. The second comparator compares the potential of the output signal from the amplifier to a second potential. The second potential corresponds to a lower threshold for causing the clipping of the output signal. The controller reduces the gain of the amplifier based on comparative results made by the first and second comparators, when either the potential of the output signal from the amplifier is higher than the first potential or lower than the second potential.

When the amplitude of the output signal from the amplifier is large, the gain of the amplifier is reduced to prevent the output signal from the amplifier from being clipped. When the amplitude of the output signal from the amplifier is not large, the gain of the amplifier is not reduced, thereby allowing that the amplifier performs sufficient amplification.

In some cases, the single package may further include a semiconductor chip, on which the microphone, the amplifier and the controller are provided.

In some cases, the microphone can be realized by one selected from a capacitive microphone, a dynamic coil microphone, and an electret capacitor microphone.

In some cases, the single package can be realized by a semiconductor package.

These and other objects, features, aspects, and advantages of the present invention will become apparent to those skilled in the art from the following detailed descriptions taken in conjunction with the accompanying drawings, illustrating the embodiments of the present invention.

### BRIEF DESCRIPTION OF THE DRAWINGS

Referring now to the attached drawings which form a part of this original disclosure:

FIG. 1 is a block diagram illustrating the configuration of a microphone device in accordance with a first preferred embodiment of the present invention;

FIG. 2 is a schematic perspective view illustrating a single unseparatable function module of the microphone device shown in FIG. 1;

FIG. 3 is a circuit diagram illustrating configurations of a microphone and an amplifier in the microphone device shown in FIG. 1;

FIG. 4 is a diagram illustrating waveforms of output signal from a voltage controlled amplifier, first and second output signals from first and second comparators, and an output signal from an OR-gate in the microphone device shown in FIG. 1;

FIG. 5 is a view illustrating variations in the amplitude of input signal into and output signals from the voltage controlled amplifier over the distance of the microphone in accordance with the embodiment of the present invention;

FIG. 6 is a view illustrating variations in the amplitude of input signal into and output signals from the amplifier over the distance of the microphone in the prior art; and

FIG. 7 is a block diagram illustrating the configuration of a conventional microphone device having a capacitive microphone.

### DETAILED DESCRIPTION OF THE INVENTION

Selected embodiments of the present invention will now be described with reference to the drawings. It will be apparent to those skilled in the art from this disclosure that the following descriptions of the embodiments of the present invention are provided for illustration only and not for the purpose of limiting the invention as defined by the appended claims and their equivalents.

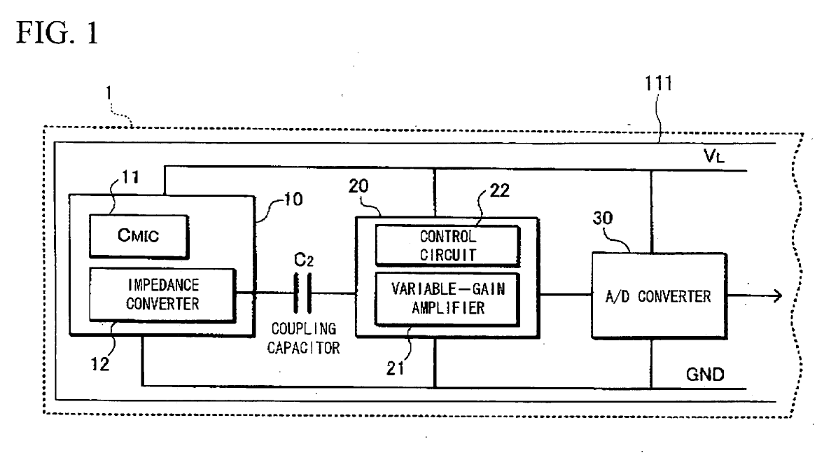

FIG. 1 is a block diagram illustrating the configuration of a microphone device in accordance with a first preferred embodiment of the present invention. A microphone device 1 performs as an electroacoustic transducer that converts an input acoustic pressure into an electrical signal and amplifies the electrical signal for output. The microphone device 1 is realized by a single semiconductor package 111. The single semiconductor package 111 may include, but is not limited to, a microphone unit 10, an amplifier 20, an analog-to-digital converter 30, and a coupling capacitor C2. Namely, the microphone unit 10, the amplifier 20, the analog-to-digital converter 30, and the coupling capacitor C2 are integrated in the single semiconductor package 111. The microphone unit 10 may include, but is not limited to, a capacitive microphone C_{MIC} 11, and an impedance converter 12. The amplifier 20 may include, but is not limited to, a voltage controlled amplifier 21 and a control circuit 22. The microphone unit 10 is connected through the coupling capacitor C2 to the amplifier 20. The microphone unit 10, the amplifier 20, and the analog-to-digital converter 30 are each connected to a power voltage line V_{L} and also to a ground line GND.

In the microphone unit 10, the capacitive microphone C_{MIC} 11 receives an input of acoustic pressure. The acoustic pressure causes variation of the capacitance of the capacitive microphone C_{MIC} 11. The capacitive microphone C_{MIC} 11 generates a voltage signal in accordance with the input acoustic pressure. The impedance converter 12 performs impedance-conversion of the voltage signal. The impedance-converted electrical signal is transmitted through the coupling capacitor C2 to the amplifier 20. In the amplifier 20, the gain of the voltage controlled amplifier 21 is controlled by the control circuit 22. The impedance-converted electrical signal is amplified by the voltage controlled amplifier 21, thereby generating an amplified voltage signal as an analog signal. The amplified voltage signal is transmitted to the analog-to-digital converter 30. The analog-to-digital converter 30 converts the amplified voltage signal as the analog signal into a digital signal. The digital signal is then transmitted to a next stage circuit that is not illustrated. It is also possible as a modification that the single semiconductor package 111 is free of the analog-to-digital converter 30 so that the amplified voltage signal as the analog signal is transmitted to the next stage circuit that is not illustrated.

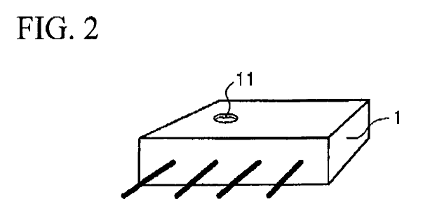

The microphone unit 10 may preferably be formed by a micromachinery technique, such as Micro Electro Mechanical System (MEMS). In some cases, the microphone unit 10 and the amplifier 20 may be formed on the same semiconductor chip such as a silicon chip. In other cases, the microphone unit 10 and the amplifier 20 may be formed on different semiconductor chips such as silicon chips. In other case, the microphone unit 10, the amplifier 20 and the analog-to-digital converter 30 may be formed on the same semiconductor chip such as a silicon chip. In other case, the microphone unit 10 may be formed on the semiconductor chip different from the semiconductor chip on which the amplifier 20 and the analog-to-digital converter 30 are formed. The semiconductor chip is mounted on the single semiconductor package 111 that is reduced in size. The single semiconductor package 111 may be realized by a metal package or a printed circuit board (PCB). The microphone device 1 can be modularized into a single unseparatable function module, wherein a sound collector of the capacitive microphone C_{MIC} 11 is exposed. FIG. 2 is a schematic perspective view illustrating a single unseparatable function module of the microphone device 1. The microphone device 1 can be designed independent from the issue of how to design any follower device that can be connected through a cable to the microphone device 1. This makes it easier to design the microphone device 1.

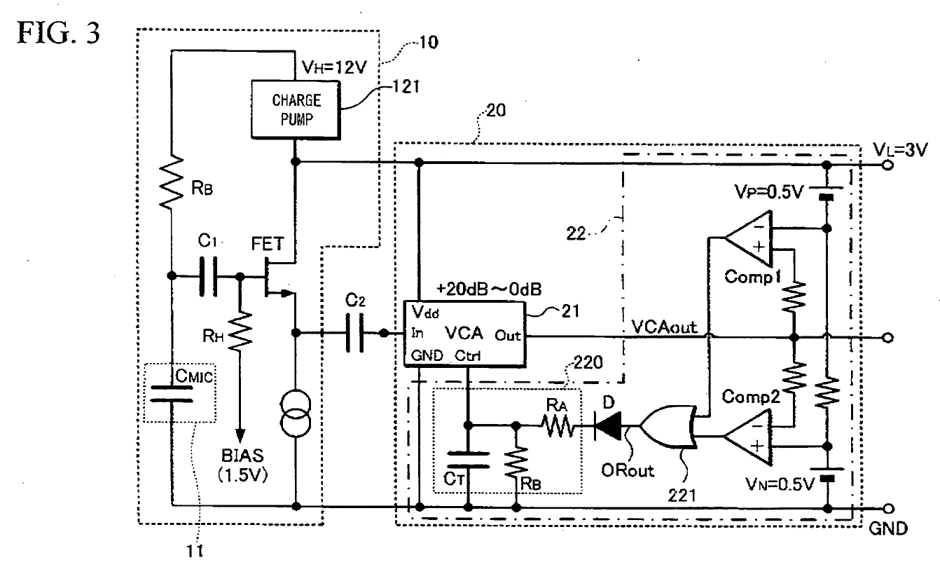

FIG. 3 is a circuit diagram illustrating configurations of the microphone unit 10 and the amplifier 20 in the microphone device 1. As described above, the microphone unit 10 includes the capacitive microphone C_{MIC} 11. The microphone unit 10 includes a charge pump 121 which boosts a power voltage V_{L} of 3V up to a boosted voltage V_{H} of 12V. The boosted voltage V_{H} of 12V is applied through a high resistance R_{B} to the capacitive microphone C_{MIC} 11, while a ground voltage GND is also applied to the capacitive microphone C_{MIC} 11. Thus, the capacitive microphone C_{MIC} 11 is biased by the boosted voltage V_{H} of 12V. The microphone unit 10 further includes a coupling capacitor C1, a high resistance R_{H}, and an impedance converter field effect transistor FET. The impedance converter field effect transistor FET has a gate that is connected to the high resistance R_{H} and also to the couping capacitor C1. Abias voltage BIAS of 1.5 V is applied to the high resistance R_{H}.

The input acoustic pressure causes slight capacitive variation of the capacitive microphone C_{MIC} 11. The capacitive microphone C_{MIC} 11 causes the voltage variation in proportional to the acoustic pressure by the capacitive variation and charges of the capacitor due to the bias voltage. The voltage variation is fetched as an output voltage signal from the source of the impedance converter field effect transistor FET. The impedance converter field effect transistor FET can be used in order to reduce the output impedance of the capacitive microphone C_{MIC} 11.

As described above, the amplifier 20 includes the voltage controlled amplifier 21 and the control circuit 22 that controls the gain of the voltage controlled amplifier 21. The voltage controlled amplifier 21 is adapted to have a gain variable range from 20 dB to 0 dB. The gain varies according to the voltage level of an input signal through a control terminal Ctrl of the voltage controlled amplifier 21. Increase in the voltage level of the input signal though the control terminal Ctrl decreases the amplification degree. Decrease in the voltage level of the input signal though the control terminal Ctrl increases the amplification degree. For example, a gain of +20 dB can be obtained upon input of 0V into the control terminal Ctrl. The voltage controlled amplifier 21 further has a driving terminal Vdd that receives driving voltage of 3V and a ground terminal GND that is grounded.

The control circuit 22 includes first and second comparators Comp1, Comp2, an OR-gate 221, and a time constant circuit 220. The first and second comparators Comp1, Comp2 receive the output signal VCAout from the voltage controlled amplifier 21. The first comparator Comp1 compares the output signal VCAout to a first threshold voltage. The first threshold voltage is lower by V_{P}=0.5V than the power voltage of V_{L}=3V. When the output signal VCAout exceeds the first threshold voltage, the first comparator Comp1 outputs the high level. The first comparator Comp1 detects the higher value of the output signal VCAout from the voltage controlled amplifier 21. The second comparator Comp2 compares the output signal VCAout to a second threshold voltage. The second threshold voltage is higher by V_{N}=0.5V than the ground voltage GND. When the output signal VCAout is lower than the second threshold voltage, the second comparator Comp2 outputs the high level. The second comparator Comp2 detects the lower value of the output signal VCAout from the voltage controlled amplifier 21.

V_{L}-V_{P} is regarded as the higher voltage level when the output signal VCAout from the voltage controlled amplifier 21 is clipped. Vn is regarded as the lower voltage level when the output signal VCAout from the voltage controlled amplifier 21 is clipped. First and second output signals from the first and second comparators Comp1, Comp2 can be used as distortion-detection signals.

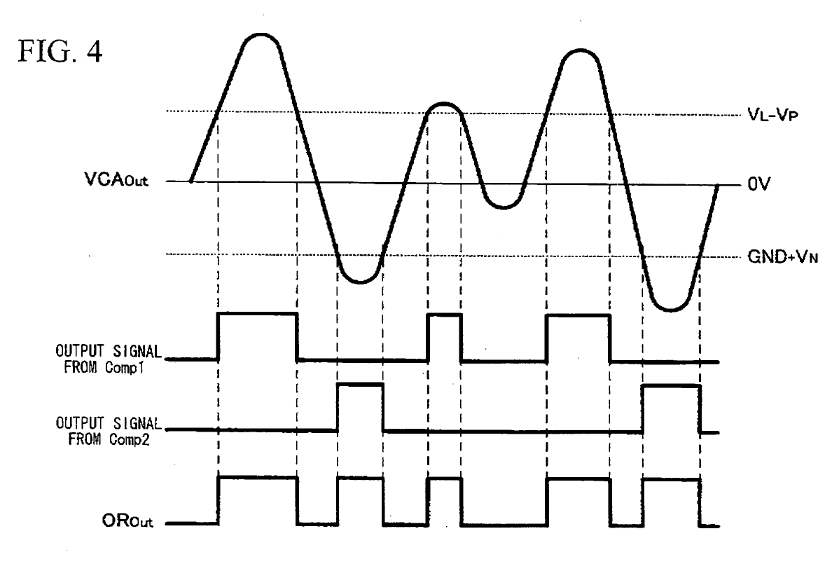

FIG. 4 is a diagram illustrating waveforms of output signal VCAout from the voltage controlled amplifier 21, first and second output signals from the first and second compatators Comp1, Comp2, and an output signal ORout from the OR-gate. When the output signal VCAout exceeds V_{L}-V_{P}, the first comparator Comp1 output “high”. When the output signal VCAout is lower than V_{L}-V_{P}, the first comparator Comp1 output “law”. When the output signal VCAout is lower than GND +V_{N}, the second comparator Comp2 output “high”. When at least one of the first and second comparators Comp1, Comp2 outputs “higW”, the OR-gate outputs “high”.

With reference back to FIG. 3, the time constant circuit 220 is connected through a diode D to the OR-gate 221. The tune constant circuit 220 is also connected to the control terminal Ctrl of the voltage controlled amplifier 21. The time constant circuit 220 is used to convert the digital output signal ORout from the OR-gate 221 into an analog signal that is to control the voltage controlled amplifier 21. The time constant circuit 220 includes a capacitor C_{T} and resistances R_{A} and R_{B}. The resistance R_{A} is connected in series to the capacitor C_{T}. The resistance R_{B} is also connected in series to the capacitor C_{T}, provided that the resistances R_{A} and R_{B} are connected in parallel to each other. Thus, the time constant circuit 220 allows setting a time constant for rising and another time constant for falling separately. The resistance R_{A} is higher than the resistance R_{A}. In this case, rising of the output signal ORout depends on the time constant that is given by the resistance R_{A} and the capacitor C_{T}, and falling of the output signal ORout depends on the other time constant that is given by the resistance R_{B} and the capacitor C_{T}. It is also possible as a modification that the time constant circuit 220 can be realized by a normal circuit configuration of a pair of a capacitor and a resistance.

The gain of the voltage controlled amplifier 21 is controlled based on the output signals from the first and second comparators Comp1, Comp2. When large sound is continued to be input into the microphone, the gain of the voltage controlled amplifier 21 is controlled so that the maximum amplitude of the output signal VCAout from the voltage controlled amplifier 21 corresponds to (V_{L}−V_{P})−Vn, for example, (3−0.5)−0.5=2V.

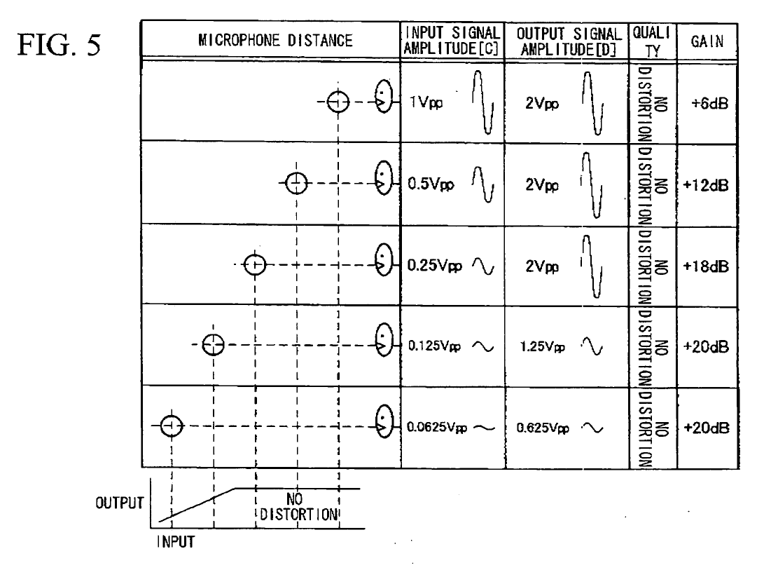

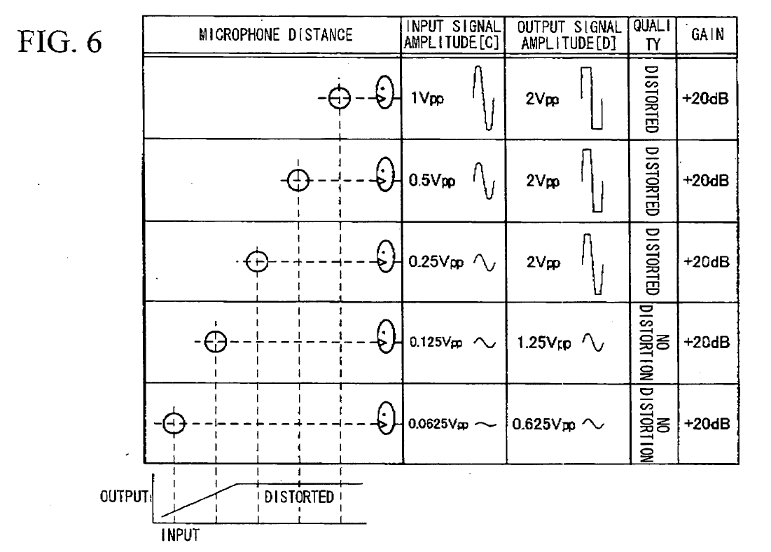

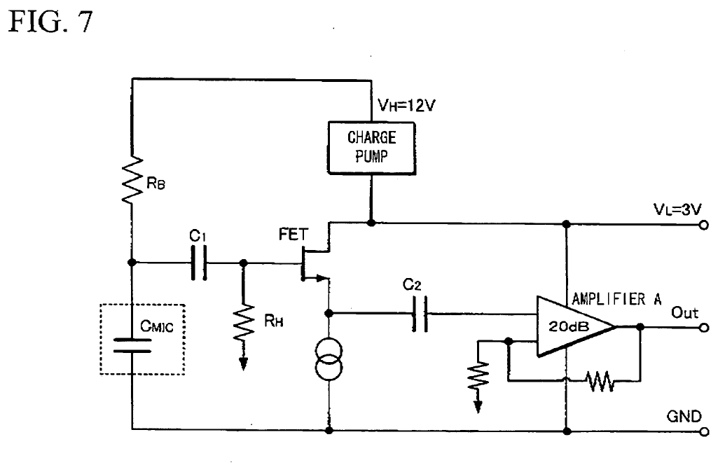

FIG. 5 is a view illustrating variations in the amplitude of input signal into and output signals VCAout from the voltage controlled amplifier 21 over the distance of the microphone C_{MIC} in the microphone device shown in FIG. 1 in accordance with the embodiment of the present invention. FIG. 6 is a view illustrating variations in the amplitude of input signal into and output signals Out from the amplifier “A” over the distance of the microphone C_{MIC} in the conventional microphone device shown in FIG. 7. FIGS. 5 and 6 show the amplitude [C] of an input signal that is input into the voltage controlled amplifier 21 and the amplitude [D] of the output signal VCAout that is output from the voltage controlled amplifier 21, while the distance of the microphone C_{MIC} varies but the sound pressure is maintained constant.

As shown in FIG. 5, when the distance of the microphone C_{MIC} is far and the amplitude [C] of the input signal is 0.0625 Vpp, the amplitude [D] of the output signal is 0.625Vpp, and the output signal ORout from the OR-gate 221 is low level. The gain of the voltage controlled amplifier 21 is maximized to be +20 dB. The degree of the amplification of the voltage controlled amplifier 21 is sufficient. Since the input signal is small, the output signal is undistorted even the maximum gain is obtained.

As shown in FIG. 6, when the distance of the microphone C_{MIC} is far and the amplitude [C] of the input signal is 0.0625 Vpp, the amplitude [D] of the output signal is 0.625Vpp. The gain of the amplifier A is maximized to be +20 dB. The degree of the amplification of the amplifier A is sufficient. Since the input signal is small, the output signal is undistorted even the maximum gain is obtained.

With reference gain to FIG. 5, when the distance of the microphone C_{MIC} comes closer to a sound source and the amplitude [C] of the input signal is 0.125 Vpp, the amplitude [D] of the output signal is 1.25Vpp, and the output signal ORout from the OR-gate 221 is low level. The gain of the voltage controlled amplifier 21 is fixed at +20 dB. The degree of the amplification of the voltage controlled amplifier 21 is sufficient. Since the input signal is small, the output signal is undistorted even the maximum gain is obtained.

With reference gain to FIG. 6, when the distance of the microphone C_{MIC} comes closer to the sound source and the amplitude [C] of the input signal is 0.125 Vpp, the amplitude [D] of the output signal is 1.25Vpp. The gain of the amplifier A is maximized to be +20 dB. The degree of the amplification of the amplifier A is sufficient. Since the input signal is small, the output signal is undistorted even the maximum gain is obtained.

With reference gain to FIG. 5, when the distance of the microphone C_{MIC} comes closer to the sound source and the amplitude [C] of the input signal is 0.25 Vpp, the gain of the voltage controlled amplifier 21 is adjusted to be +18 dB so that the amplitude [D] of the output signal is 2Vpp, thereby obtaining undistorted output signal.

With reference gain to FIG. 6, when the distance of the microphone C_{MIC} comes closer to the sound source and the amplitude [C] of the input signal is 0.25 Vpp and the gain of the amplifier A is fixed at +20 dB, the amplitude [D] of the output signal is clipped at 2Vpp, whereby the output signal is distorted.

With reference gain to FIG. 5, when the distance of the microphone C_{MIC} comes further closer to the sound source and the amplitude [C] of the input signal is 0.5 Vpp, the gain of the voltage controlled amplifier 21 is adjusted to be +12 dB so that the amplitude [D] of the output signal is 2Vpp, thereby obtaining undistorted output signal.

With reference gain to PIG. 6, when the distance of the microphone C_{MIC} comes closer to the sound source and the amplitude [C] of the input signal is 0.5 Vpp and the gain of the amplifier A is fixed at +20 dB, the amplitude [D] of the output signal is largely clipped at 2Vpp, whereby the output signal is largely distorted.

With reference gain to FIG. 5, when the distance of the microphone C_{MIC} comes further closer to the sound source and the amplitude [C] of the input signal is 1 Vpp, the gain of the voltage controlled amplifier 21 is adjusted to be +6 dB so that the amplitude [D] of the output signal is 2Vpp, thereby obtaining undistorted output signal.

With reference gain to FIG. 6, when the distance of the microphone C_{MIC} comes closer to the sound source and the amplitude [C] of the input signal is 1 Vpp and the gain of the amplifier A is fixed at +20 dB, the amplitude [D] of the output signal is largely clipped at 2Vpp, whereby the output signal is largely distorted.

When the sound pressure is large, the gain of the voltage controlled amplifier 21 is adjusted or reduced so that the output signal from the voltage controlled amplifier 21 is free of any substantial strain. Even if the distance of the microphone C_{MIC} largely varies, the high quality output signal free of any strain can be obtained. Since the gain adjustment of the voltage controlled amplifier 21 is available at real time, the microphone device 1 can be applicable to a microphone for audio collection having wide dynamic ranges in silent and non-silent states, such as a speaking microphone.

The present invention can be applicable to not only the above-described capacitive microphone for capacitance detection, but also any types of microphone such as a dynamic coil microphone, and an electret capacitor microphone.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An electroacoustic transducer comprising:
a single package;
a microphone provided in the single package, the microphone converting an acoustic pressure into an electrical signal;
an amplifier provided in the single package, the amplifier amplifying the electrical signal that is output from the microphone, the amplifier being configured to allow the gain to be adjustable; and
a controller provided in the single package, the controller controlling the gain of the amplifier, with reference to the level of an output signal from the amplifier, so as to prevent the output signal from being clipped.

2. The electroacoustic transducer according to claim 1, further comprising:
an impedance converter provided in the single package, the impedance converter being interposed between the microphone and the amplifier, the impedance converter reducing the output impedance of the microphone.

3. The electroacoustic transducer according to claim 1, wherein the controller further comprises:
a first comparator that compares the potential of the output signal from the amplifier to a first potential, the first potential corresponding to an upper threshold for causing the clipping of the output signal; and
a second comparator that compares the potential of the output signal from the amplifier to a second potential, the second potential corresponding to a lower threshold for causing the clipping of the output signal, and
wherein the controller reduces the gain of the amplifier based on comparative results made by the first and second comparators, when either the potential of the output signal from the amplifier is higher than the first potential or lower than the second potential.

4. The electroacoustic transducer according to claim 2, wherein the controller further comprises:
a first comparator that compares the potential of the output signal from the amplifier to a first potential, the first potential corresponding to an upper threshold for causing the clipping of the output signal; and
a second comparator that compares the potential of the output signal from the amplifier to a second potential, the second potential corresponding to a lower threshold for causing the clipping of the output signal, and
wherein the controller reduces the gain of the amplifier based on comparative results made by the first and second comparators, when either the potential of the output signal from the amplifier is higher than the first potential or lower than the second potential.

5. The electroacoustic transducer according to claim 1, further comprising:
a semiconductor chip, on which the microphone, the amplifier and the controller are provided.

6. The electroacoustic transducer according to claim 2, further comprising:
a semiconductor chip, on which the microphone, the amplifier and the controller are provided.

7. The electroacoustic transducer according to claim 1, wherein the microphone is one selected from a capacitive microphone, a dynamic coil microphone, and an electret capacitor microphone.

8. The electroacoustic transducer according to claim 2, wherein the microphone is one selected from a capacitive microphone, a dynamic coil microphone, and an electret capacitor microphone.

9. The electroacoustic transducer according to claim 1, wherein the single package is a semiconductor package.

10. The electroacoustic transducer according to claim 2, wherein the single package is a semiconductor package.
